(19) United States
(12) Patent Application Publication
(10) Pub. No.: US 2013/0278057 A1
(43) Pub. Date: Oct. 24, 2013

(54) POS TERMINAL

(71) Applicant: TOSHIBA TEC KABUSHIKI KAISHA, TOKYO (JP)

(72) Inventor: Toshinori Fukuta, Shizuoka-ken (JP)

(21) Appl. No.: 13/850,430

(22) Filed: Mar. 26, 2013

Related U.S. Application Data
(60) Provisional application No. 61/615,990, filed on Mar. 27, 2012.

(51) Int. Cl. H02J 7/00

(52) U.S. Cl. CPC H02J 7/0013; H02J 7/0052
USPC 307/29; 320/107

(57) ABSTRACT

According to an embodiment, a POS terminal comprises a battery unit and a control unit. The battery unit configured to accommodate a plurality of batteries. The control unit configured to be accommodated in the battery unit, acquire the charge storage voltage of each battery and determine the battery to be charged according to the acquired charge storage voltages.

### CROSS-REFERENCE TO RELATED APPLICATIONS

This application is based upon and claims the benefit of priority from U.S. Provisional Application No. 61/615,990 filed on Mar. 27, 2012; the entire contents of which are incorporated herein by reference.

### FIELD

Embodiments described herein relate to a technology for supplying electric power for a POS terminal.

### BACKGROUND

The conventional POS (Point Of Sales) terminal runs only on a electric power from a commercial power supply, and no terminal is disclosed which runs on an electric power from a battery.

### BRIEF DESCRIPTION OF THE DRAWINGS

FIG. 1 shows external views of a POS terminal according to an embodiment.

FIG. 2 is a block diagram showing the hardware of a POS terminal according to an embodiment.

FIG. 3 is a first flowchart showing an example of the actions of a POS terminal according to an embodiment.

FIG. 4 is a second flowchart showing an example of the actions of a POS terminal according to an embodiment.

### DETAILED DESCRIPTION

According to an embodiment, a POS terminal comprises a battery unit and a control unit. The battery unit configured to accommodate a plurality of batteries. The control unit configured to be accommodated in the battery unit, acquire the charge storage voltage of each battery and determine the battery to be charged according to the acquired charge storage voltages.

According to the embodiment, the POS terminal has a plurality of batteries which can be charged by the same charger. The main system and the thermal printer of the POS terminal are supplied electric power by different batteries, respectively.

According to the embodiment, the POS terminal determines and controls the charging order of the plurality of batteries by the same charger. In addition, the POS terminal selects the more charge-efficient battery or a battery of high importance that is capable of prolonging the action time of the system preferentially when the battery is charged.

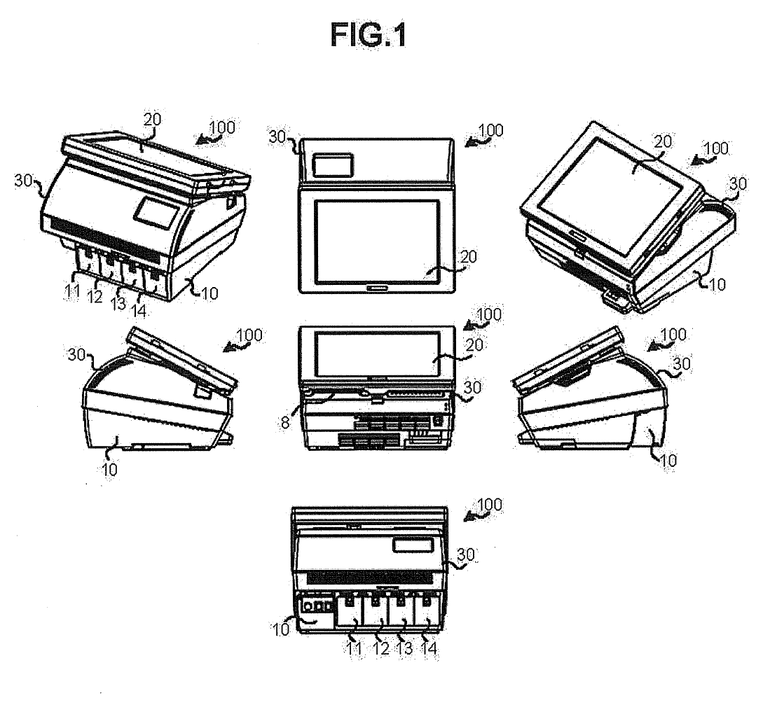

Embodiments are described in detail below with reference to accompanying drawings. FIG. 1 shows external views of a POS terminal according to the embodiment. The upper left part of FIG. 1 is a rear oblique view of the POS terminal 100, the upper center part is an upper plan view, and the upper right part is a front oblique view. In addition, the middle left part of FIG. 1 is a left side view of the POS terminal 100, the middle center part is a front view, the middle right part is a right side view, and the lower center part is a rear view. A system unit 30 is configured on the upper side of the POS terminal 100, and a battery unit 10 for accommodating four batteries 11, 12, 13 and 14 are configured below the system unit 30.

The system unit 30 is provided with a touch panel display 20 and a thermal printer 8 (printer unit). The touch panel display 20, receives operations such as fingertip pressing and pen tip pressing of the user, and also displays information for the user. The operation side and the display side of the touch panel display 20 face upward and are inclined by a given angle to be recognized from above. The thermal printer 8, which is a unit for printing a receipt, is configured in such a manner that the receipt discharge port of the thermal printer 8 faces the operator.

The batteries 11-14 are a lithium ion battery pack which is mounted or dismounted from the main body basket of the POS terminal 100. A faulted battery or a battery that is degraded after being used for a long time can be replaced by the user. The user can pull out the batteries 11-14 from the rear part of the POS terminal to dismount the batteries or insert the batteries 11-14 into the battery unit 10 from the rear part of the POS terminal to mount the batteries.

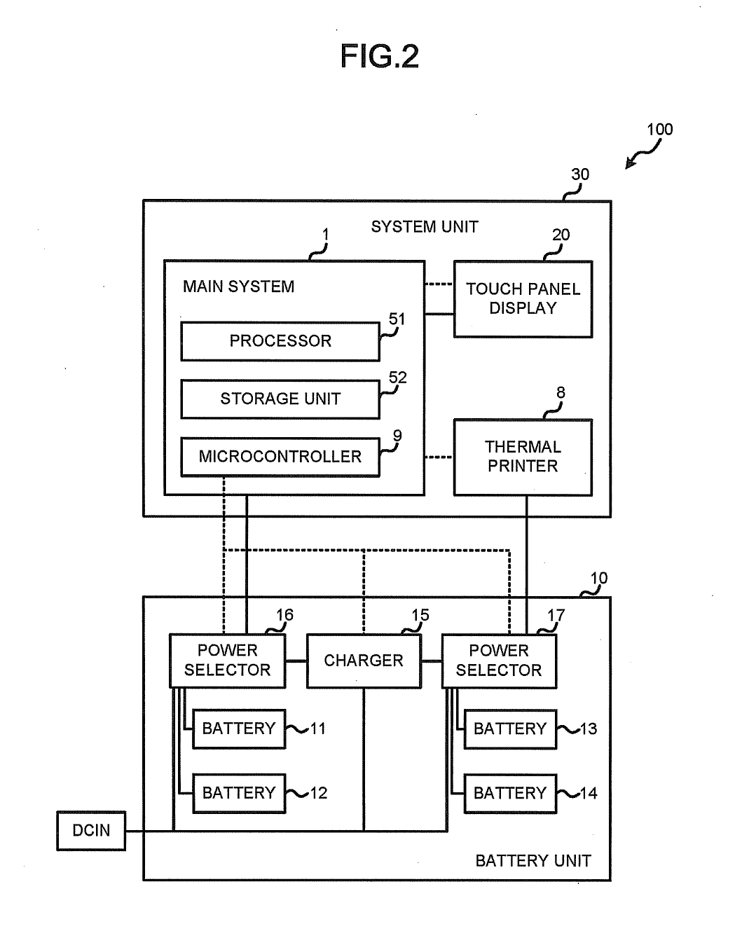

FIG. 2 is a block diagram showing an example of the structure of the POS terminal 100. In FIG. 2, the dash line represents a control signal line, and the thick solid line represents an electric power supplying line.

In addition to the touch panel display 20 and the thermal printer 8, the system unit 30 further comprises a main system 1, which consists of one or more base plates and comprises a processor 51, a storage unit 52 and a microcomputer 9 (control unit).

The processor 51, which is, for example, a CPU (Central Processing Unit) or an MPU (Micro Processing Unit), takes charge of the control over the hardware in the POS terminal 100. The processor 51 executes a program that is imported to the storage unit 52 in advance, thereby controlling the hardware in the POS terminal 100. The storage unit 52, which is a unit for storing pre-imported programs or various data, comprises a volatile primary storage apparatus and a non-volatile auxiliary storage apparatus.

The microcomputer 9 switches an electric power supplying source between the batteries 11-14 and a commercial power supply (DCIN in FIG. 2). Further, the microcomputer 9 further conducts a control to determine a battery to be charged from the batteries 11-14. The microcomputer 9 may be installed in the battery unit 10. In addition, the function and control of microcomputer 9 may also be executed by the processor 51 in accordance with the program pre-stored in the storage unit 52.

The battery unit 100 comprises a charger 15 and power selectors 16 and 17, which control the switch according to an instruction signal from the microcomputer 9.

When connected with a commercial power supply, the POS terminal 100 runs on the power from the commercial power supply. The charger 15 switches a battery for charging electric power which is supplied by the commercial power supply from among the batteries 11-14. The charger 15 makes the switch to charge any one of the batteries 11-14.

The power selector 16 selects a power supply for the main system 1 from the commercial power supply, the battery 11 or the battery 12. The power selector 16 makes a switch so that when the power supply from the commercial power supply is cut off, a power supply can be provided from the battery 11 or 12. The power selector 17 selects a power supply for the thermal printer 8 from the commercial power supply, the battery 13 or the battery 14. The power selector 17 makes a switch so that when the power supply from the commercial power supply is cut off, a power supply can be provided from the battery 13 or 14.

In this manner, in the embodiment, the main system 1 and the thermal printer 8 are powered by two power supply systems, respectively. The batteries are restricted to a rated current allowable range which, however, can be broken when the main system 1 is overloaded and the thermal printer 8 conducts a high density printing operation. Thus, in the embodiment, the batteries are divided to supply power for the main system 1 and the thermal printer respectively. Further, in the embodiment, the touch panel display 20 is powered by the system which supplies power for the main system 1.

Further, in the embodiment, two batteries 11 and 12 are provided to supply power for the main system 1, and two batteries 13 and 14 are provided to supply power for the thermal printer 8. Thus, in the provided. As a result, a battery can function while the other battery is being replaced. Additionally, although each of the main system 1 and the thermal printer 8 is powered by two batteries, the present invention is not limited to this. There may be three or more batteries for supplying power for the main system 1, and three or more batteries for supplying power for the thermal printer 8. Further, the number of the batteries for supplying power for the main system 1 may be different from that of the batteries for supplying power for the thermal printer 8. Further, if within a rated range, one battery and one system may be utilized to supply power for all the units in the POS terminal 100.

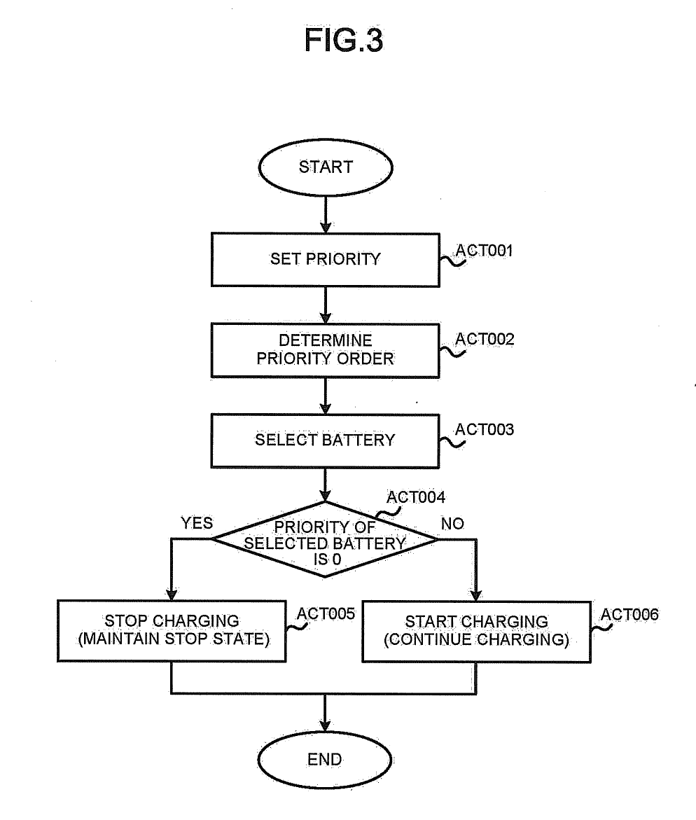

FIG. 3 is a flowchart exemplarily showing a process of selecting a charged object from the batteries 11-14. The microcontroller 9 acquires the current voltages (the accumulated or charged voltages of the batteries 11-14) of the batteries 11-14 and sets priorities for the batteries 11-14 according to the charge storage voltages (ACT 001). In the embodiment, the levels of the priorities are set to be level 0-level 3. The level 0 is the lowest level indicating that no charging is needed, and the level 3 is the highest level. The microcontroller 9 may acquire the charge storage voltages of each of the batteries 11-14 from a voltage measurement circuit contained in each battery. Such a voltage measurement circuit may also be located in the microcontroller 9.

The priority setting realized in ACT001 is described in detail below. For example, it is set that the charge storage voltage of the battery 11 is V11 and Low, Mid and High are three constants. The constants accord with the following relationship: Low≦Mid≦High. The microcontroller 9 sets the priority of the battery 11 as follows:

When 0≦V11≦Low, the microcontroller 9 sets the priority of the battery 11 to be level 3.

When Low<V11≦Mid, the microcontroller 9 sets the priority of the battery 11 to be level 2.

When Mid<V11≦High, the microcontroller 9 sets the priority of the battery 11 to be level 1.

When High<V11, the microcontroller 9 sets the priority of the battery 11 to be level 0.

The microcontroller 9 also implements the action above for the batteries 12-14.

Next, the microcontroller 9 determines priority order (ACT002). ACT002 is described below. The microcontroller 9 makes a switch among the four batteries in accordance with the following order so that the batteries can be charged in accordance with the priority order.

(ACT002-1) the microcontroller 9 sets a battery with a higher priority to be charged preferentially and increases the priority of it.

(ACT002-2) when two batteries are equal in priority, the microcontroller 9 sets the battery supplying power for the main system 1 to be charged prior to the battery supplying power for the thermal printer 8. If the power of the main system 1 is low, the action time of the POS terminal will be shortened even if the thermal printer 8 is fully charged by a battery. Thus, the microcontroller 9 sets a higher charging priority for the main system 1.

(ACT002-3) if two batteries are equal in priority level and supply power for the same object, the microcontroller 9 sets the battery currently having a lower charging voltage to be charged prior to the other.

The microcontroller 9 selects the battery having the highest priority order (the headmost battery) (ACT003) and determines whether or not the priority level of the selected battery is 0 (ACT004). If the case where the priority level of the selected battery is not 0 (ACT004: No), the microcontroller 9 outputs a control signal to the charger 15 to start to charge the selected battery (ACT006); alternatively, if the selected battery is being charged, the microcontroller 9 conducts a control to continue the current charging (ACT006). On the other hand, If the priority level of the battery selected in ACT003 is (ACT004: Yes), the microcontroller 9 conducts a control so as not to charge any battery (ACT005); alternatively, if the selected battery is being charged, the microcontroller 9 outputs a control signal to the charger 15 to stop the current charging (ACT005).

The higher the charge storage voltage of a battery is, the longer the charging for the battery takes. The battery is continuously charged until the battery is 80% charged, and then charged at a lowered speed. Thus, when the priority level of the selected battery is 0, that is, the selected battery is almost fully charged, if the charging is continued, a great amount of time will be taken while little power can be charged. Thus, the charging is stopped in the present embodiment. In addition, an overcharging is prevented through the actions of ACT004 and ACT005.

Further, the determination of ACT 004 is equivalent to the determination on whether or not to take the constant High as a threshold value to charge a battery. That is, when the charge storage voltage of the battery having the highest priority (the battery selected in ACT003) is higher than a threshold value (constant High), the microcontroller 9 conducts a control so as not to charge any battery.

The microcontroller 9 carries out the actions shown in FIG. 3 periodically.

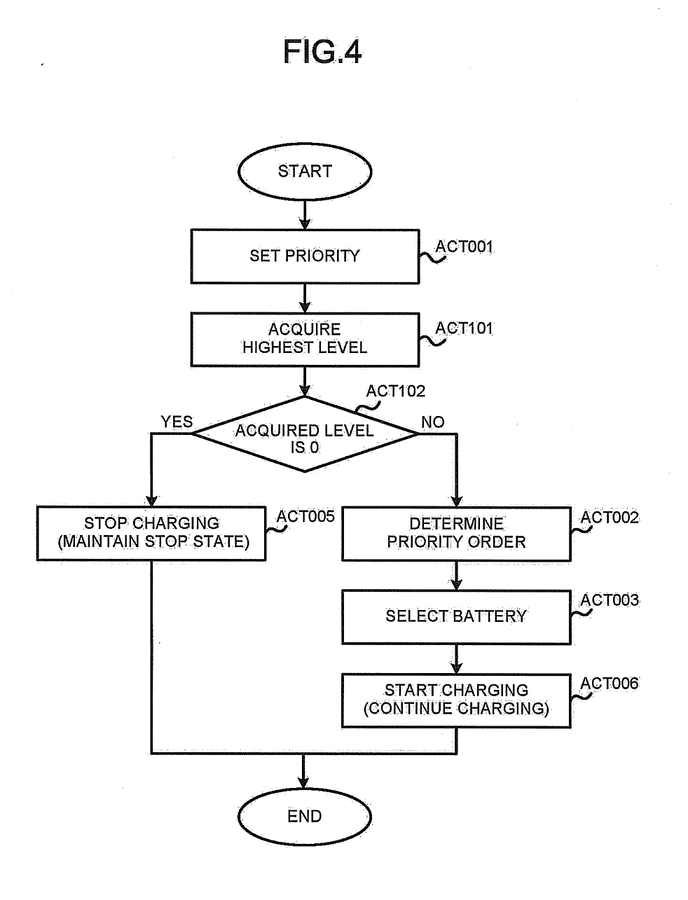

The determination on whether or not to charge a battery is made in ACT 004 in the second phase of the exemplary process shown in FIG. 3, however, the microcontroller 9 may carry out the determination in the first phase of the process. FIG. 4 shows an example of the process. In addition, the same reference symbols in FIG. 3 and FIG. 4 denotes the same action.

The microcontroller 9 sets the levels of the batteries 11-14 (ACT001) and acquires the highest level (ACT 101). If the level acquired is 0 (ACT 102: Yes), the microcontroller 9 conducts a control to stop the charging (ACT 005).

On the other hand, if the level acquired is not 0 (ACT102: No), the microcontroller 9 determines priority order (ACT002) and selects the battery having the highest priority order (ACT 003). The microcontroller 9 starts or maintains the charging for the battery selected (ACT 006).

By selecting a battery to be charged as shown in FIG. 3 and FIG. 4, a battery which can be charged effectively or changed to prolong the action time of the POS terminal 100 can be charged. Thus, when compared with a case where charging priority order is not taken into consideration, the present invention remains more power in batteries or in a battery of higher importance even if a charging process is interrupted before all the batteries are charged.

The battery selection action shown in FIG. 3 and the battery determination action shown in FIG. 4 are not limited to those described herein. The microcontroller 9 may acquire the charge storage voltages of the batteries 11-14 and determine the battery having the lowest voltage to be a battery to be charged. A unique battery to be charged may be determined in different ways.

As stated above, in accordance with the technology disclosed herein, a plurality of batteries can be charged effectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A POS terminal, comprising:
a battery unit configured to accommodate a plurality of batteries; and
a control unit configured to be accommodated in the battery unit, acquire the charge storage voltage of each battery and determine the battery to be charged according to the acquired charge storage voltages.

2. The POS terminal according to claim 1, wherein
the control unit sets a priority for each battery according to the acquired charge storage voltages and determines the battery with highest priority as to be charged.

3. The POS terminal according to claim 2, further comprising:
a main system unit configured to control the hardware of the POS terminal; and
a printer unit, wherein
some of the plurality of batteries supply electric power for the main system unit, and the other batteries supply electric power for the printer unit, and
the control unit determines the battery supplying electric power for the main system as to be charged if there are batteries that the priorities are the same.

4. The POS terminal according to claim 3, wherein
the control unit determines the battery with the lowest charge voltage as to be charged if there are batteries that the priorities are the same and supply electric power to the main system.

5. The POS terminal according to claim 2, wherein
the control unit controls so as not to charge any battery if the charge voltage of the battery with the highest priority is higher than a given value.

6. The POS terminal according to claim 1, further comprising:
a charger configured to make a switch a battery to be charged based on the determination result of the control unit.

7. The POS terminal according to claim 1, further comprising:
a main system unit configured to control the hardware of the POS terminal; and
a printer unit, wherein
some of the plurality of batteries supply electric power for the main system unit, and the other batteries supply electric power for the printer unit.

8. The POS terminal according to claim 7, wherein
there are a plurality of batteries for supplying electric power for the main system unit and a plurality of batteries for supplying electric power for the printer unit.

9. The POS terminal according to claim 8, further comprising:
a power selector configured to switch a battery to supply electric power for the main system unit according to an instruction from the control unit.

10. The POS terminal according to claim 8, further comprising
a power selector configured to switch a battery to supply electric power for the printer unit according to an instruction from the control unit.
